(19) United States
(12) Patent Application Publication
(10) Pub. No.: US 2012/0223042 A1
(43) Pub. Date: Sep. 6, 2012

(54) SYSTEM, METHOD AND APPARATUS FOR LIFTING A COMPONENT FROM A HELICOPTER IN THE FIELD

(75) Inventor: Willard E. McNiff, Henderson, NV (US)

(73) Assignee: ALL METAL MS, CORPORATION, Las Vegas, NV (US)

(21) Appl. No.: 13/402,009

(22) Filed: Feb. 22, 2012

Related U.S. Application Data
(60) Provisional application No. 61/447,873, filed on Mar. 1, 2011.

(51) Int. Cl. B66C 23/16; B66D 1/06; B66C 23/18; B66C 23/70; B66D 1/60; B66D 1/36

(52) U.S. Cl. 212/295; 254/266; 254/334; 254/369

(57) ABSTRACT

A collapsible component lift for removal and replacement of, for example, a helicopter engine or transmission in a remote location. The lift includes a mast, boom, adjustable support arm and winch. The mast is supported substantially vertical and stands next to the failed helicopter. The boom extends outwardly, over the helicopter during removal and replacement of the component (e.g. engine, transmission) and swivels away from the helicopter to access the component. A strap and winch provide lifting force. An adjustment arm connects between the mast and the boom, forming a triangle with the mast and boom. The collapsible component lift disassembles into component sections that are short enough to be transported in a maintenance helicopter that is flown to the site of the failed helicopter. Preferably, a carrying case is provided for the transportation of the individual components.

### CROSS-REFERENCE TO RELATED APPLICATION

This application is claiming the benefit of provisional application No. 61/447,873, filed Mar. 1, 2011, the disclosure of which is hereby incorporated by reference.

### FIELD

This invention relates to the field of helicopter maintenance and more particularly to a system for removing and replacing an engine or transmission of a helicopter or other device at the failure location in the field.

### BACKGROUND

It is well known that mechanical failures often occur at the worst possible time and location. For many types of vehicles, the disabled vehicle is towed to a repair facility where the failure is diagnosed and fixed. The repair facility has staff, tools, diagnostic machines, etc. for facilitating the repair. With this class of vehicles, towing is performed by pulling the vehicle (e.g. car, boat) using a tow vehicle (e.g. tow truck, tow boat) or, for wheeled vehicles, the vehicle is winched up onto a flat-bed truck and moved to the repair facility.

These procedures are not available for vehicles that are designed to reach places that are not accessible to such tow vehicles. When such a vehicle is disabled due to mechanical failure, it cannot be towed to the repair facility. Instead, the repair needs to be performed at the location of failure. In particular, helicopters are used to access locations where there are no roads, rivers, or other means for transporting a disabled helicopter back to a service facility. When a helicopter fails in a remote location, such as in a jungle or on a mountain top, it is almost impossible to return the helicopter to a repair facility. Therefore, the repair must be done in the field.

Minor helicopter repairs such as replacing a fuel pump or battery are routinely performed in the field, but often engine failure is mechanical in nature. Due to the location and weight of the helicopter engine, it is very difficult to perform repairs in the field. Since the helicopter cannot be returned to the repair facility and, often there is no reasonable way to reach the failed helicopter by means other than by a second, functioning helicopter, repair staff are limited to using replacement components that readily fit within the working helicopter to carry the replacement components to the site of the failed helicopter. It is well known that a replacement engine and/or transmission for a helicopter will fit within the cargo hull of a similar helicopter, but replacing the failed component (engine, transmission, etc.) of the failed helicopter in the field is a challenge due to the weight, size and location of the engine. A component hoist is needed to lift the failed component (e.g. engine) out of the inoperable helicopter and substitute the replacement component for the failed component. Unfortunately, existing hoists do not fit within the cargo hull of most helicopters.

What is needed is a system, apparatus and method for removing and replacing a failed component in the field.

### SUMMARY

A system, method and apparatus for removal and replacement of, for example, a helicopter engine or transmission in a remote location includes a mast, boom, adjustable support arm and winch. The mast is held in a substantially vertical orientation by a plurality of legs and leg supports. The boom extends outwardly, over the helicopter during removal and replacement of the component (e.g. engine) and swivels away from the helicopter to access and lower/loft the component (e.g. engine). A strap and winch provide lifting force. The strap passes over/through rollers and over the component and the winch winds or unwinds the strap to lift the component out for the failed helicopter and to set down the replacement or repaired component back into the failed helicopter. In some embodiments, an adjustment arm connects to the mast and the boom forming an adjustable triangle with the mast and boom, providing for height adjustment of the boom to compensate for different sizes of failed helicopters. In some embodiments, the strap passes over a movable trolley and the trolley moves along the boom to adjustably positions the strap.

The apparatus disassembles into component sections that are short enough to be transported in a maintenance helicopter that is flown to the sight of the failed helicopter. Preferably, a carrying case is provided for the transportation of the individual components of the lift.

In one embodiment, a helicopter component hoist is disclosed including a mast that has at least two detachable sections including an upper mast section and a lower mast section. The helicopter component hoist has legs, a first end of each leg being affixed to a bottom end of the lower mast section. Collapsible support arms hold the lower mast section in a substantially vertical orientation; a first end of each collapsible support arm is affixed to the lower mast section and a distal second end of each collapsible support arm is attached to a corresponding leg. A boom extends from the upper mast. A first end of the boom is pivotally connected to a top end of the upper mast section An arm has a first end removably connected to the upper mast section and a second end removably connected to an attach point on the boom. A strap is interfaced and slideably held by the boom and also interfaced and slideably held by an upper end of the upper mast section. A first end of the strap extends downward from the boom for engagement with a component of a failed helicopter and a second end of the strap is affixed to a winch which is affixed to the upper mast. The winch is operated to take in or let out the strap, thereby raising or lowering the component.

In another embodiment, a helicopter component hoist is disclosed including a mast that has at least two detachable sections including an upper mast section and a lower mast section. The helicopter component hoist has legs, a first end of each leg being affixed to a bottom end of the lower mast section. Collapsible support arms hold the lower mast section in a substantially vertical orientation; a first end of each collapsible support arm is affixed to the lower mast section and a distal second end of each collapsible support arm is attached to a corresponding leg. A first end of a boom is pivotally connected to a top end of the upper mast section. A first strap interface is positioned at a second, distal end of the boom and a second strap interface is positioned at the first end of the boom. An arm has a first end that is removably connected to the upper mast section and a second end that is removably connected to any of multiple attachment points on the boom. A strap is slideably held by the first strap interface and slideably held by the second strap interface. A first end of the strap extends downward from the boom for engagement with a component of a failed helicopter and a second end of the strap is affixed to a winch which is affixed to the upper mast. The winch is operated to take in or let out the strap, thereby raising or lowering the component.

In another embodiment, a helicopter component hoist is disclosed including a mast that has at least two detachable sections including an upper mast section and a lower mast section. The helicopter component hoist has legs, a first end of each leg being affixed to a bottom end of the lower mast section. Collapsible support arms hold the lower mast section in a substantially vertical orientation; a first end of each collapsible support arm is affixed to the lower mast section and a distal second end of each collapsible support arm is attached to a corresponding leg. A boom extends from the upper mast. A first end of the boom is pivotally connected to a top end of the upper mast section and has a first strap interface. A trolley having a second strap interface is slideably interface to the boom and positionable longitudinally along at least a portion of the boom. An arm has a first end removably connected to the upper mast section and a second end removably connected to an attach point on the boom. A strap is slideably held by the first strap interface and slideably held by the second strap interface. A first end of the strap extends downward from the boom for engagement with a component of a failed helicopter and a second end of the strap is affixed to a winch which is affixed to the upper mast. The winch is operated to take in or let out the strap, thereby raising or lowering the component.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a top plan view of an exemplary helicopter with a collapsible component lift.

FIG. 2 illustrates a front plan view of an exemplary helicopter with the collapsible component lift.

FIG. 3A illustrates a side plan view of the collapsible component lift with a trolley boom.

FIG. 3B illustrates a side plan view of the collapsible component lift with a static boom.

FIG. 4 illustrates a perspective view of the collapsible lift with the static boom.

FIG. 5 illustrates a perspective view of the trolley boom of the collapsible component lift.

FIG. 6 illustrates a side plan view of the static boom and upper mast of the collapsible component lift.

FIG. 7A illustrates an exploded view of the collapsible component lift with a trolley boom.

FIG. 7B illustrates an exploded view of the collapsible component lift with a static boom.

FIG. 8 illustrates a perspective view of an exemplary carrying case for the collapsible component lift shown holding the components of the collapsible component lift.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Although shown specifically to be transported by a helicopter, the collapsible component lift is anticipated to be transported in any way know including, but not limited to, in a backpack, land vehicle, dropped from a parachute, other type of aircraft, etc. Likewise, the collapsible component lift is shown in the repair of a failed helicopter, but is not limited in any way to only the repair of helicopters.

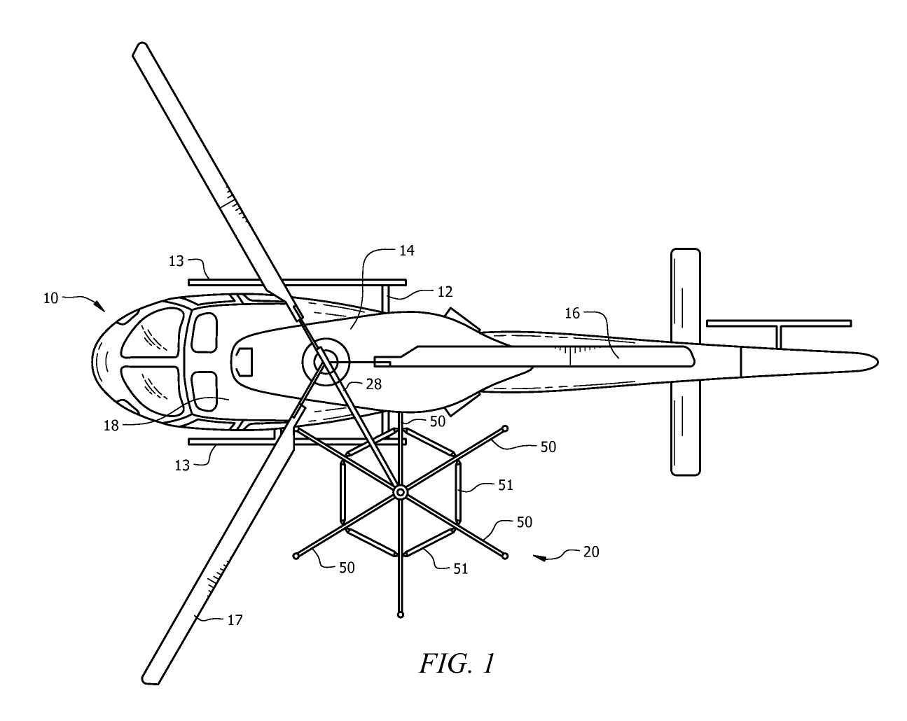

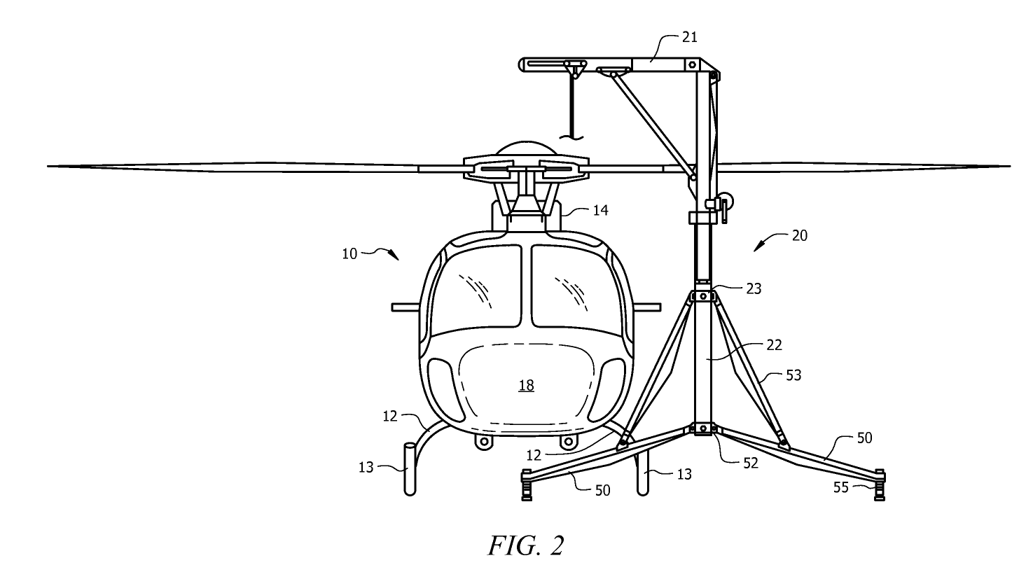

Referring to FIGS. 1 and 2, views of an exemplary helicopter 10 shown with the collapsible component lift 20 will be described. The helicopter 10 is, for example, disabled in a remote location and a maintenance helicopter (not shown) is flown to that location along with the collapsible component lift 20 and whatever replacement components are needed (e.g. engine or transmission). The exemplary helicopter 10 has a fuselage 18 and tail section 16. In FIGS. 1 and 2, the cowling 14 is shown in place, covering the engine and transmission. The cowling 14 is removed to access the engine and transmission.

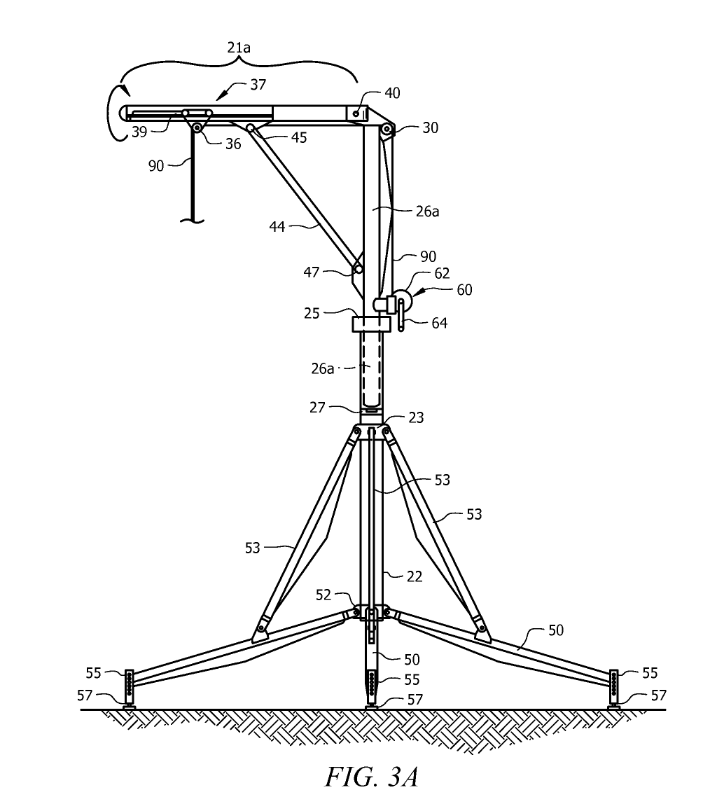

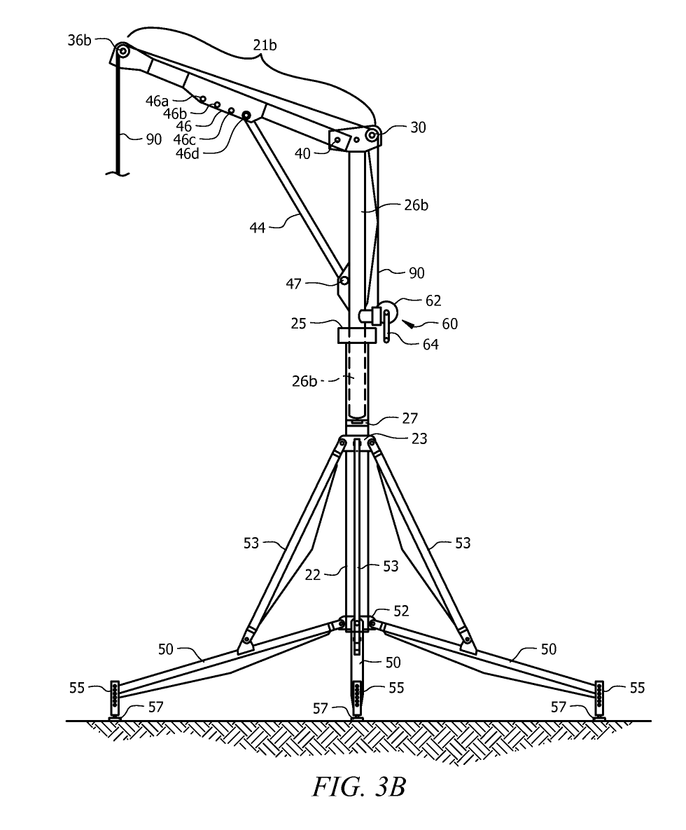

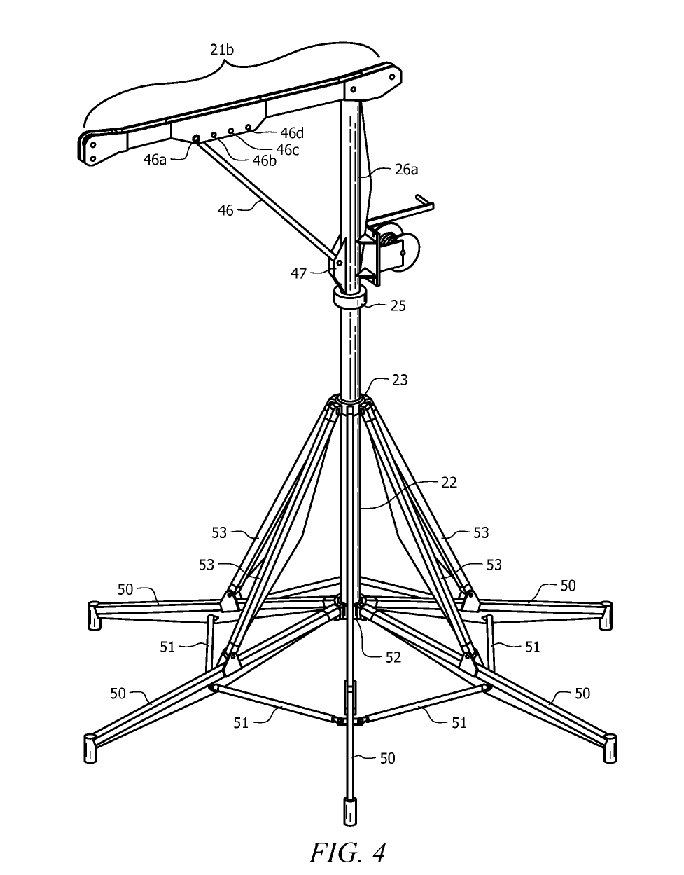

The collapsible component lift 20 is positioned near the skids 12/13. A first end of the collapsible component lift legs 50 attaches to the lower mast 22 via a connection point 52 (see FIG. 2) on the collapsible component lift 20. Level adjusters 55 (see FIGS. 3A and 3B) are positioned at a distal end of the collapsible component lift legs 50. Collapsible support arms 53 interface between the collapsible component lift legs 50 and an upper attach point 23 on the lower mast 22 to keep the lower mast 22 positioned substantially vertically. In some embodiments, stabilizers 51 extend between each of the collapsible component lift legs 50 to maintain substantially equal spacing between the collapsible component lift legs 50. The stabilizers 51 are anticipated to be either stiff spacing members or, resilient members (as shown in FIG. 4) similar to bungee cords. In embodiments in which the stabilizers 51 are resilient, some adjustment of the spacing between the collapsible component lift legs 50 is possible to account for placement on uneven terrain.

The boom 21 extends out over the helicopter 10 for lifting of components on/off the helicopter 10.

Individual mast and boom components of the collapsible component lift 20 are shown and will be described in detail in subsequent figures.

Referring to FIG. 3A, a side plan view of the collapsible component lift 20 with a trolley boom 21a is shown. Although shown with peculiar overall dimensions and assembly, other configurations and dimensions are anticipated, achieving the same results. In general it is desirable that each individual component not exceed the cargo area dimensions of the target rescue vehicle. For example, if the collapsible component lift 20 is to be carried in a back pack, it is desirable that the components not be too long as to interfere with walking/climbing.

In this example of the collapsible component lift 20, the mast 22/26a comprises two sections, a lower mast 22, and an upper mast 26a. It is anticipated that any number of mast sections 22/26a be used to achieve the required height for accessing the failed component (e.g. engine—not shown) of the helicopter 10. The mast sections 22/26a disengage into component mast sections 22/26a that are short enough as to fit within, for example, the maintenance helicopter (not shown) for transportation to the sight of the failed helicopter 10. Although any known means for connecting the mast sections 22/26a to each other is anticipated, in this embodiment, the bottom end of the upper mast section 26a fits snuggly within the top end of the lower mast section 22 and limited in penetration depth by, for example, a thrust bearing 27. In some embodiments, the top end of the lower mast section 22 has a bearing 25 such as a crown bearing 25 to ease rotation of the upper mast section 26a with respect to the lower mast section 22. It is anticipated that the mast sections 22/26a are made from any suitable material and/or cross-sectional geometry, for example, aluminum tubing.

The lower mast section 22 is supported and held substantially vertical by component lift legs 50 that attach to the lower mast section 22 at the connection point 52. Level adjusters 55 and feet 57 at a distal end of the collapsible component lift legs 50 enable adjustments to compensate for uneven surfaces as often is the case in remote locations. It is anticipated that, in some embodiments, the feet 57 swivel to conform to irregularities in the surfaces. The support arms 53 interface between the collapsible component lift legs 50 and an upper attach point 23 on the lower mast 22. The support arms 53 provide structural support and help keep the lower mast 22 positioned substantially vertically when in use. The support arms 53, in some embodiments, either collapse against the lower mast 22 or are removable for transporting the collapsible component lift 20.

The bearings 25/27 enable rotation of the upper mast section 26a and, therefore, the trolley boom 21a with respect to the failed helicopter 10. Although it is anticipated that the bearings 25/27 are made of any suitable material, in one embodiment, the bearings 25/27 are made of nylon.

In some embodiments, a level sensing device (not shown) is attached to one of the mast sections 22/26a to facilitate proper, vertical orientation of the mast sections 22/26a, being that it is anticipated that the failed helicopter 10 is often located on uneven surfaces.

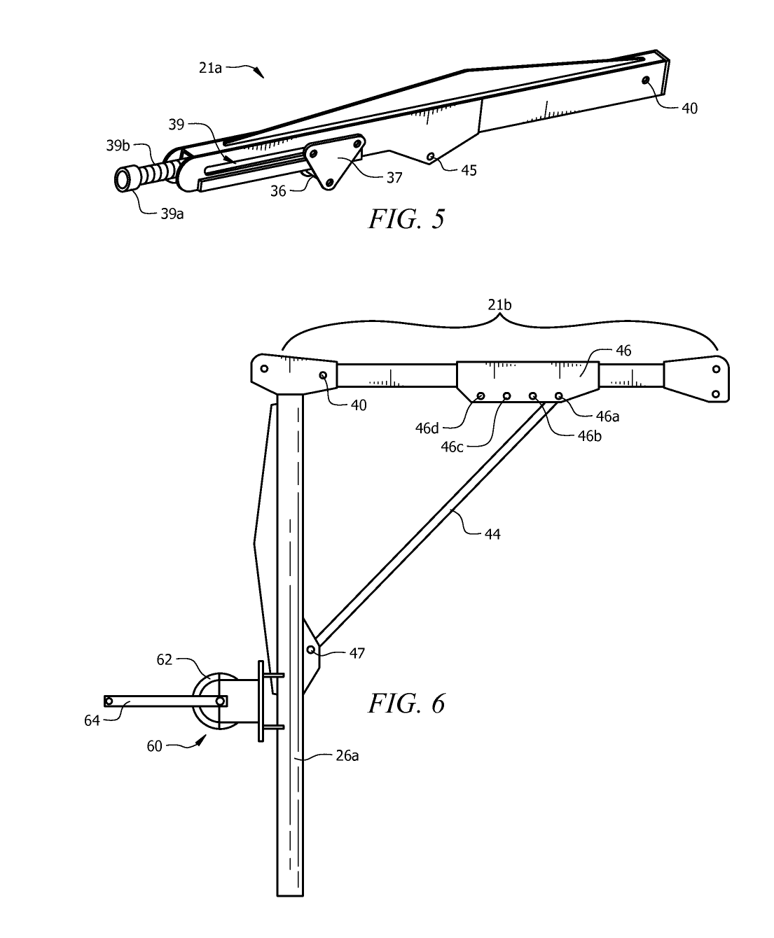

Attached by a pivot 40 to a top end of the upper mast section 26a is a trolley boom 21a. The trolley boom 21a extends outward from the mast 22/26a and reaches over the helicopter 10 facilitating removal and/or replacement of the target component, as shown in FIG. 1. The trolley boom 21a is shown in detail in FIG. 5. The trolley boom 21a has a trolley 37 over which or through which a strap 90 passes to facilitate component lifting. The strap 90 is, for example, a 2 inch nylon strap capable of supporting the weight of the target component. A nylon strap 90 is preferred, though not required, to reduce scratching of the helicopter 10 that may occur with a chain. Any known strap 90 is anticipated, including a rope, or a chain having sufficient tensile strength and flexibility. The strap 90 is threaded over/between the rollers 30/36 and removably attached at one end to the helicopter 10 component as known in the industry such as with a hook (not shown). The other end of the strap 90 is attached to a winch 60. A handle 64 of the winch 60 is cranked to wrap the strap 90 around the winch spool 62 and, resultantly, lift the component. The handle 64 is turned in reverse to lower the component. Any known winch 60 is anticipated including motorized winches or hoists. In some embodiments, the winch 60 includes a ratchet mechanism.

The trolley 37 is adjusted along a track 39 by a mechanism. Although there are many mechanisms 39 possible, one exemplary mechanism is a knob 39a (see FIG. 5) and threaded shaft 39b (see FIG. 5) that are fixed to, yet rotatable within the trolley boom 21a. The exemplary mechanism is interfaced to a threaded hole (not visible) in a flange of the trolley 37, the threads matching in pitch and diameter of the threaded shaft such that, as the threaded shaft 39b is rotated by turning of the knob 39a, the trolley 37 moves up or down the threaded shaft 39b and, hence, up or down the track 39, dependent upon the direction of rotation of the knob 39a.

To provide leverage and structural strength, an arm 44 connects at one end to a bracket 45 on the trolley boom 21a and at the opposite end to a bracket 47 on the upper mast 26a.

Referring to FIG. 3B, a side plan view of the collapsible component lift 20 with a stationary boom 21b is shown. Although shown with particular overall dimensions and assembly arrangement, other configurations and dimensions are anticipated to achieve the same results. In this example of the collapsible component lift 20, the mast 22/26b comprises two sections, a lower mast 22, and an upper mast 26b. It is anticipated that any number of mast sections 22/26b be used to achieve the required height for accessing the failed component (e.g. engine—not shown) of the helicopter 10. The mast sections 22/26b disengage into component mast sections 22/26b that are short enough as to fit within the maintenance helicopter (not shown) for transportation to the site of the helicopter 10. Although any known means for connecting the mast sections 22/26b to each other is anticipated, in this embodiment, the bottom end of the upper mast section 26b fit snuggly within the top end of the lower mast section 22 and limited in penetration depth by, for example, a thrust bearing 27. In some embodiments, the top end of the lower mast section 22 has a bearing 25 such as a crown bearing 25 to ease rotation of the upper mast section 26b with respect to the lower mast section 22. It is anticipated that the mast sections 22/26b are made from any suitable material and/or cross-sectional geometry, for example, aluminum tubing.

The lower mast section 22 is supported and held substantially vertical by component lift legs 50 that attach to the lower mast section 22 at the connection point 52. Level adjusters 55 and feet 57 at a distal end of the collapsible component lift legs 50 provide for adjustments that compensate for uneven surfaces as often is the case in remote locations. It is anticipated that, in some embodiments, the feet 57 swivel to conform to irregularities in the surfaces. The support arms 53 interface between the collapsible component lift legs 50 and an upper attach point 23 on the lower mast 22. The support arms 53 provide structural support and help keep the lower mast 22 positioned substantially vertically when in use. In some embodiments, the upper attach point 23 is a sleeve. The support arms 53, in some embodiments, either collapse against the lower mast 22 or are removable for transporting the collapsible component lift 20.

The bearings 25/27 enable rotation of the upper mast section 26b and, therefore, the stationary boom 21b with respect to the failed helicopter 10. Although it is anticipated that the bearings 25/27 are made of any suitable material, in one embodiment, the bearings 25/27 are made of nylon.

In some embodiments, a level sensing device (not shown) is attached to one of the mast sections 22/26b to facilitate proper, vertical orientation of the mast sections 22/26b, being that it is anticipated that the failed helicopter 10 is often located on uneven surfaces.

Attached by a pivot 40 to a top end of the upper mast section 26b is a stationary boom 21b. The stationary boom 21b extends outward from the mast 22/26b and reaches over the helicopter 10 facilitating removal and/or replacement of the component as shown in FIG. 1. The stationary boom 21b is shown in detail in FIG. 6. The stationary boom 21b has a pulley 36b through/over which a strap 90 passes to facilitate component lifting. The strap 90 is, for example, a 2 inch nylon strap capable of supporting the weight of the target component. A nylon strap 90 is preferred to reduce scratching of the helicopter 10. Any known strap 90 is anticipated, including a rope, or a chain having sufficient tensile strength and flexibility. The strap 90 is threaded over/between the rollers 30/36b and removably attached at one end to the helicopter 10 component as known in the industry such as with a hook (not shown). The other end of the strap 90 is attached to a winch 60. A handle 64 of the winch 60 is cranked to wrap the strap 90 around the winch spool 62 and, thereby, lifting the component. The handle 64 is turned in reverse to lower the component. Any known winch 60 is anticipated including motorized winches or hoists. In some embodiments, the winch 60 includes a ratchet mechanism.

To provide leverage, structural strength and adjustability to the stationary boom 21b, an arm 44 removably connects at one end to a bracket 46 on the stationary boom 21b and at the opposite end to a bracket 47 on the upper mast 26b. By selecting one of the several holes 46a-46d (at least one hole is required) in the bracket 46 on the stationary boom 21b, the angle of the stationary boom 21b is adjusted to compensate for different sizes and styles of helicopters 10. Since the stationary boom 21b is pivotally connected to the upper mast 26b by a pivot 40, the stationary boom 21b is freely raised and lowered to adapt to the height of several types of helicopters. Once adjusted to the proper height, the stationary boom 21b is held and supported by a pin, screw, or other device between the adjustment arm 44 and one of the adjustment holes 46a-d, thereby holding and supporting the stationary boom 21b at the proper height.

Referring now to FIGS. 4 and 6, a perspective view of the collapsible lift 20 with the stationary boom 21b (FIG. 4) and a plan view of the stationary boom 21b are shown. The base components 50/51/52/53/55/57/22/23 are as described in FIGS. 1 and 2.

In this view, the static boom 21b has a bracket 46 that is shown with four attachment points 46a-46d, although any number of attachment points 46a-d is anticipated. Note, for simplicity, the attachment points 46a-46d are holes on the bracket 46 through which fasteners pass (not visible). For example, a fastener such as a pin or a screw passes through a hole in one side of the bracket 46, then through a hole in one end of the arm 44, and then through a hole in the opposite side of the bracket 46; and preferably the protruding portion of the fastener is bent or fastened at the opposite side to prevent the fastener from falling out. Note that it is anticipated that any type and any number of attachment points are anticipated, including attachment points that do not require a fastener such as snap-type attachment points. The attachment point 46a farthest from the upper mast 26a positions the static boom 21a at a lower position and the attachment point 46d closest to the upper mast 26b positions the static boom 21b at a higher position.

Referring now to FIG. 5, a perspective view of the trolley boom 21a of the collapsible component lift 20 is shown. In this, the pivot 40 (hole) is shown, though not connected to the mast 26a (the mast 26a is not shown in FIG. 5). Likewise, the bracket 45 is shown disconnected from to the arm 44 for clarity reasons. The trolley 47 travels along a slot 39 under control of a mechanical system such as a threaded shaft 39b with a knob 39a at one end. In this example, the threaded shaft 39b is rotatably held to the trolley boom 21a and a flange (not visible) of the trolley 37 has mating threads such that, as the knob 39a is turned in a first direction and the threaded shaft 39b turns in that direction, the trolley 37 moves in in a first direction along the slot 39. Reversing of the turning moves the trolley 37 in the opposite direction along the slot 39. Any mechanism for moving the trolley 37 is anticipated, including no mechanism, in which the trolley 37 is manually positioned to a location along the slot 39. In the later, it is preferred to have stops or detents to retain the trolley 37 in the selected position.

The strap 90 wraps over a pin or wheel interface 36. The pin or wheel interface 36 is connected to the trolley 37.

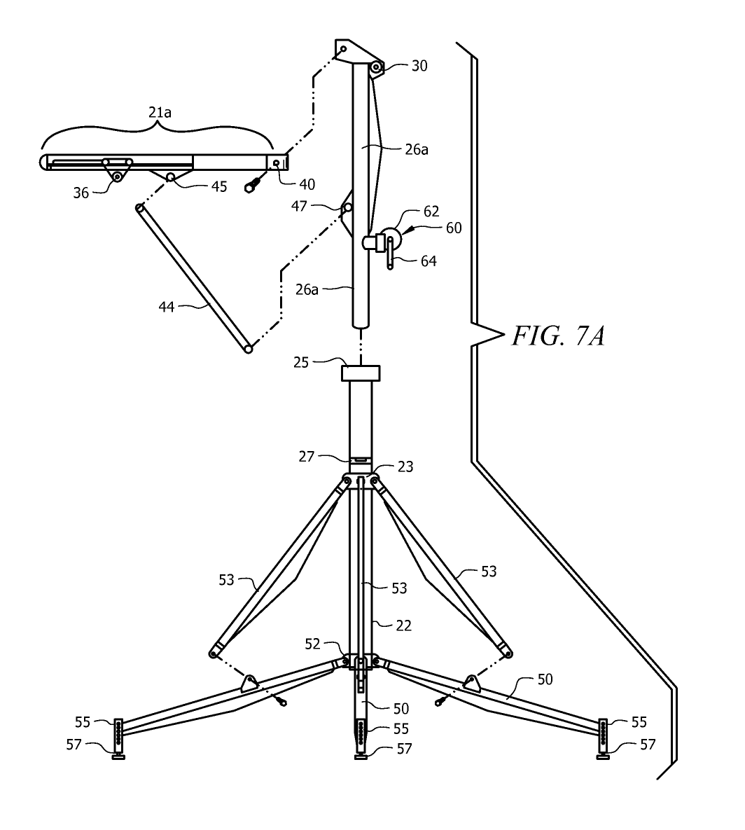

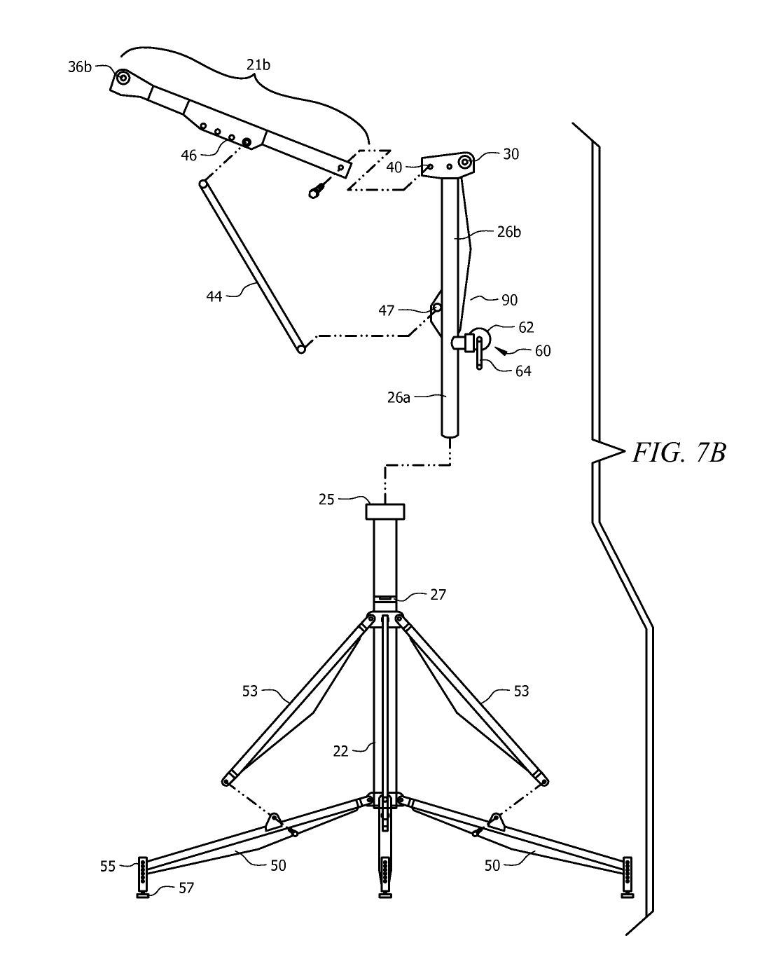

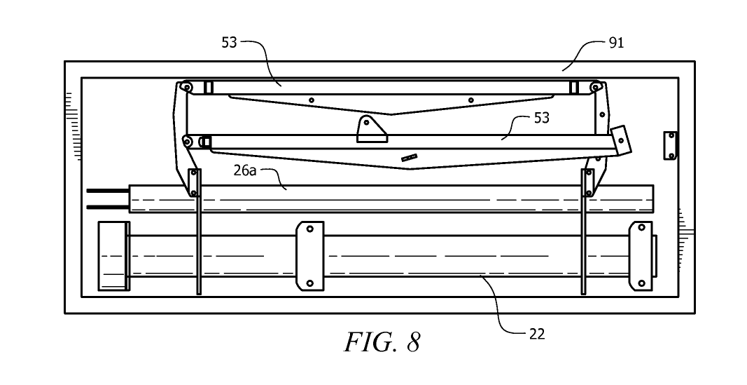

Referring now to FIGS. 7A and 7B, exploded view of the collapsible component lift with a trolley boom (FIG. 7A) and a static boom (FIG. 7B) are shown. In each view, the collapsible component lifts with either boom 21a/21b are shown with the individual components separated. The individual components, once separated, are easily transported to/from the site of a failed helicopter 10 and are sized (in length) to fit within the rescue helicopter or other carrying system. Since turbulence is often encountered, it is desired that the components are held within a carrier (see FIG. 8), though there is no requirement for such a carrier and, for some uses, the components are strapped or tied together for safety reasons, etc.

Referring now to FIG. 8, a perspective view of an exemplary carrying case for the collapsible component lift is shown holding the components of the collapsible component lift. Although it is anticipated that, after disassembly, the collapsible component lift 20 is carried in any suitable container, box, sack, etc., it is preferred, especially for air travel within a rescue craft, that the components be held statically and apart to prevent damage to the rescue craft, rattles, noise, as well as damage to components of the collapsible component lift 20 due to friction during transportation.

Many such carrying cases are anticipated, the carrying case shown in FIG. 8 being an example of such. As shown in FIG. 8, the carrying case has a frame 91 made of a sturdy material such as aluminum, plastic, PVC, or any other sturdy material. It is preferred, though not required, that the material be light weight.

In some embodiments, there is a plurality of aligned holes (not visible) for accepting mast 22/26a, the boom sections (not visible), the leg supports 53, etc. In some embodiments, there are retainer clips (not shown) for holding the mast 22/26a and boom 21a/21a sections within the frame. In some embodiments, a handle (not shown) is pivotally attached to the frame to facilitate carrying by maintenance personnel.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A helicopter component hoist comprising:
a mast, the mast comprising at least two detachable sections including an upper mast section and a lower mast section;
a plurality of legs, a first end of the plurality of legs affixed to an end of the lower mast section;
a plurality of collapsible support arms, a first end of each collapsible support arm affixed to the lower mast section and a distal second end of each collapsible support arm attached to a corresponding leg of the plurality of legs such that the collapsible support arm holds the lower mast section in a substantially vertical orientation;
a boom, a first end of the boom pivotally connected to a top end of the upper mast section;
an arm, a first end of the arm removably connected to the upper mast section and a second end of the arm removably connected to the boom;
a strap, the strap interfaced and slideably held by the boom, the strap interfaced and slideably held by an upper end of the upper mast section, a first end of the strap extending downward from the boom for engagement with a component of a failed helicopter and a second end of the strap affixed to a winch, the winch operated to take in or let out the strap, thereby raising or lowering the component.

2. The helicopter component hoist of claim 1, wherein the upper mast section fits snuggly within an upper end of the lower mast section.

3. The helicopter component hoist of claim 2, further comprising at least one bearing selected from a crown bearing and a thrust bearing, the at least one bearing interfaced to the lower mast section thereby enabling rotation of the upper mast section with respect to the lower mast section.

4. The helicopter component hoist of claim 1, wherein a second, distal end of each of the plurality of legs further comprises a level adjuster.

5. The helicopter component hoist of claim 1, further comprising a plurality of stabilizers that extend between adjacent legs.

6. The helicopter component hoist of claim 1, wherein the stabilizers are resilient members.

7. The helicopter component hoist of claim 1, wherein the strap is interfaced and slideably held by the boom by a roller, the roller positioned substantially at a second, distal end of the boom.

8. The helicopter component hoist of claim 7, wherein the second end of the arm removably connects to any one of a plurality of attach points on the boom, thereby providing an angular adjustment of the boom.

9. The helicopter component hoist of claim 1, wherein the strap is interfaced and slideably held by a roller, the roller attached to a trolley, the trolley slideably interfaced to the boom and longitudinally positionable along at least a portion of the boom.

10. The helicopter component hoist of claim 9, wherein the trolley is positioned longitudinally along the at least the portion of the boom by a threaded shaft that is interfaced to the boom and interfaced to threads in the trolley, such that turning of the threaded shaft in one direction results in the trolley moving longitudinally in a first direction and turning of the threaded shaft in an opposite direction results in the trolley moving longitudinally in an opposite direction.

11. The helicopter component hoist of claim 1, further comprising a carrying case, the carrying case having locations for each component of the helicopter component hoist.

12. The helicopter component hoist of claim 1, wherein the winch includes a crank and a ratchet, the crank interfaced to a spool such that turning of the crank results in turning of the spool, the ratchet having a lock mode that allows rotation of the spool in one direction and prevents rotation in the opposite direction during lifting and the ratchet having an un-lock mode allowing rotation of the spool in an opposing direction.

13. A helicopter component hoist comprising:
a mast, the mast comprising at least two detachable sections including an upper mast section and a lower mast section;
a plurality of legs, a first end of the plurality of legs affixed to a bottom end of the lower mast section;
a plurality of collapsible support arms, a first end of each collapsible support arm affixed to the lower mast section and a distal second end of each collapsible support arm attached to a corresponding leg of the plurality of legs such that the collapsible support arms hold the lower mast section in a substantially vertical orientation;
a boom, a first end of the boom pivotally connected to a top end of the upper mast section, a first strap interfacing at a second, distal end of the boom and a second strap interfacing at the first end of the boom;
an arm, a first end of the arm removably connected to the upper mast section and a second end of the arm removably connected to any one of a plurality of attach points on the boom;
a strap, the strap interfaced and slideably held by the first strap interface and slideably held by the second strap interface, a first end of the strap extending downward from the boom for engagement with a component of a failed helicopter and a second end of the strap affixed to a winch, the winch affixed to the upper mast, and the winch operated to take in or let out the strap, thereby raising or lowering the component.

14. The helicopter component hoist of claim 13, wherein the upper mast section fits snuggly within an upper end of the lower mast section.

15. The helicopter component hoist of claim 14, further comprising at least one bearing selected from a crown bearing and a thrust bearing, the at least one bearing interfaced to the lower mast section thereby enabling rotation of the upper mast section with respect to the lower mast section.

16. The helicopter component hoist of claim 13, wherein the winch includes a crank and a ratchet, the crank interfaced to a spool such that turning of the crank results in turning of the spool, the ratchet having a lock mode that allows rotation of the spool in one direction and prevents rotation in the opposite direction during lifting and the ratchet having an un-lock mode allowing rotation of the spool in an opposing direction.

17. A helicopter component hoist comprising:
a mast, the mast comprising at least two detachable sections including an upper mast section and a lower mast section;
a plurality of legs, a first end of the plurality of legs affixed to a bottom end of the lower mast section;
a plurality of collapsible support arms, a first end of each collapsible support arm affixed to the lower mast section and a distal second end of each collapsible support arm attached to a corresponding leg of the plurality of legs such that the collapsible support arms hold the lower mast section in a substantially vertical orientation;
a boom, a first end of the boom pivotally connected to a top end of the upper mast section, a first strap interface at the first end of the boom;
a trolley having a second strap interface, the trolley slideably interface to the boom and longitudinally positionable along at least a portion of the boom;
an arm, a first end of the arm removably connected to the upper mast section and a second end of the arm removably connected to an attachment point on the boom;
a strap, the strap interfaced and slideably held by the first strap interface and slideably held by the second strap interface, a first end of the strap extending downward from the boom for engagement with a component of a failed helicopter and a second end of the strap affixed to a winch, the winch affixed to the upper mast, and the winch operated to take in or let out the strap, thereby raising or lowering the component.

18. The helicopter component hoist of claim 17, wherein the upper mast section fits snuggly within an upper end of the lower mast section.

19. The helicopter component hoist of claim 18, further comprising at least one bearing selected from a crown bearing and a thrust bearing, the at least one bearing interfaced to the lower mast section thereby enabling rotation of the upper mast section with respect to the lower mast section.

20. The helicopter component hoist of claim 17, wherein the trolley is positioned longitudinally along the at least the portion of the boom by a threaded shaft, the threaded shaft is interfaced to the boom and the threaded shaft is interfaced to threads in the trolley, thereby turning of the threaded shaft in one direction results in the trolley moving longitudinally in a first direction and turning of the threaded shaft in an opposite direction results in the trolley moving longitudinally in an opposite direction.
